(19) United States
(12) Patent Application Publication
(10) Pub. No.: US 2009/0107897 A1
(43) Pub. Date: Apr. 30, 2009

(54) AUTOMATIC FLUSHING APPARATUS OF MEMBRANE FILTER IN WATER PURIFIER

(75) Inventors: Yung-Gi Kim, Cheonlabook-do (KR); Su-Jun Lee, Daejeon (KR)

Correspondence Address: MCDERMOTT WILL & EMERY LLP, 18191 VON KARMAN AVE., SUITE 500, IRVINE, CA, 92612-7108, US

(73) Assignee: Woongjin Coway Co., Ltd., Choongcheongnam-do (KR)

(21) Appl. No.: 11/909,703

(22) PCT Filed: Mar. 20, 2006
(86) PCT No.: PCT/KR06/01014

§ 371 Date: Apr. 9, 2008

(30) Foreign Application Priority Data
Apr. 4, 2005 (KR) 10-2005-0028042

(51) Int. Cl. B01D 65/02

(52) U.S. Cl. 210/108

(57) ABSTRACT

A water purifier including a sediment filter (100), a pre-carbon filter (200) and a membrane filter (300) to sequentially filter raw water. An automatic flushing apparatus of the membrane filter (300) includes an LPS (120) for detecting water pressure in a water pipe connected between the sediment filter (100) and the pre-carbon filter, a pump (130) for pumping water fed from the sediment filter (100) to the pre-carbon filter (200), a controller (600) for enabling controlled flushing of the water from the inside of the membrane filter (300) from a time point where a pumping voltage is detected, and a flush regulating valve (310) for opening a flush pipe of the membrane filter (300). The water is flushed out from the inside of the membrane filter (300) through the flush regulating valve (310) while removing scales from the inside of the membrane filter (300) under flushing pressure thereof.

### TECHNICAL FIELD

The present invention relates to an automatic flushing apparatus of a membrane filter in a water purifier, more particularly, which can automatically flush water from the inside of the membrane filter in a predetermined time period according to purifying time of the membrane filter in order to periodically and automatically remove scales from the inside of the membrane filter under the pressure of the water flushed therefrom.

### BACKGROUND ART

In general, water purifiers are designed to filter foreign materials (or scales) such as harmful carcinogens from raw water such as tap water (potable water), and thus provide clean, purified water. According to purifying types, such water purifiers can be classified into a purifier adopting natural filtering water, a tap water purifier, a purifier adopting ion exchange resin, a purifier adopting reverse osmosis and so on.

Of such conventional water purifiers, a conventional water purifier adopting reverse osmosis will be described with reference to FIG. 1.

FIG. 1 is a construction view of a purifying apparatus of a conventional water purifier. The purifying unit of the water purifier, as shown in FIG. 1, includes a sediment filter 10, a pre-carbon filter 20, a membrane filter 30, a post-carbon filter 40 and a purified water tank 50. In a typical water purifying process, raw water is purified sequentially through the filters and then contained in the purified water tank 50.

Describing functions of the filters, the sediment filter 10 is fed with the raw water from a hydrant (not shown), and removes various floating materials such as dust and scales from the raw water through a fine filter mesh of 50. The pre-carbon filter 20 is fed with the filtered water from the sediment filter 10, and removes harmful chemical substances such as Trihalo Methane (THM), synthetic detergent and pesticide as well as chlorine components from the water through the adsorption of activated carbon. The membrane filter 30 is made of reverse osmosis membrane of 0.001□ to filter Na, bacteria, viruses and radioactive substances together with heavy metals such as Pb and As from the water. The post-carbon filter 40 serves to remove unpleasant taste or smell, coloring matter and so on from the water.

Furthermore, the water purifier includes a Float Level Controller (FLC) 11, a Low Pressure Sensor (LPS) 12 and a pump 13 on a raw water pipe connected between the sediment filter 10 and the pre-carbon filter 20.

The FLC 11 closes the raw water pipe between the sediment filter 10 and the pre-carbon filter 20 when the raw water therein exceeds an adequate level. The LPS 12 provides a pumping voltage if the water pressure in the raw water pipe between the sediment filter 10 and the pre-carbon filter 20 is an adequate water pressure or higher. The pump 13 pumps the raw water from the sediment filter 10 to the pre-carbon filter 20 when applied with the pumping voltage from the LPS 12.

The membrane filter 30 is connected to the post-carbon filter 40 via a water pipe WP, and connected to a flush pipe OP which is installed with a manual valve 31.

The lifetime of the membrane filter is determined by the condition of the raw water. For example, if the raw water contains a large quantity of scales (foreign materials) such as calcium carbonate, the membrane filter may be clogged quickly and thus cannot perform its own function. Thus, in order to remove such scales, a user should open the manual valve to flush the raw water out from the inside of the membrane filter so that the scales are also discharged on the raw water.

However, such a conventional water purifier has a drawback in that the scales inside the membrane filter are removed by manual operation of the manual valve and thus the user should detect the time point for removing scales, and in that the scale removing process is annoying.

Furthermore, since such a scale removing process is performed by the detection and manual operation of the user, the scales are not removed at adequate times. If the scales are not removed at the adequate times, the lifetime of the membrane filter is shortened.

### DISCLOSURE OF INVENTION

### Technical Problem

The present invention has been proposed to solve the foregoing problems and therefore an object of certain embodiments of the invention is to provide an automatic flushing apparatus of a membrane filter in a water purifier which can automatically flush water from the inside of the membrane filter in a predetermined time period according to purifying time of the membrane filter in order to periodically and automatically remove scales from the inside of the membrane filter under the pressure of the water flushed therefrom and thus prolong the lifetime of the membrane filter.

### Technical Solution

According to an aspect of the invention for realizing the object, there is provided an automatic flushing apparatus of a membrane filter in a water purifier, which includes a sediment filter, a pre-carbon filter and the membrane filter to sequentially filter raw water, the apparatus comprising: an LPS for detecting water pressure in a water pipe connected between the sediment filter and the pre-carbon filter to supply a pumping voltage if the water pressure is an adequate pressure or higher; a pump for pumping water fed from the sediment filter to the pre-carbon filter upon receiving the pumping voltage from the LPS; a controller for enabling controlled flushing of the water from the inside of the membrane filter for a period and at an interval of a first preset time from a time point where the pumping voltage is detected; and a flush regulating valve for opening a flush pipe of the membrane filter during the controlled flushing by the controller, whereby the water is flushed out from the inside of the membrane filter through the flush regulating valve while removing scales from the inside of the membrane filter under flushing pressure thereof.

Preferably, the controller includes: a voltage detector for detecting a pumping voltage applied to the pump via the LPS; a microprocessor for supplying a flush signal at an interval of the first preset time and for a period of a second preset time from a time point where a detection voltage is received from the voltage detection; a power switch for supplying an AC flush voltage in response to the flush signal of the microprocessor; and a flush power supply for converting the AC flush voltage from the power switch into a DC flush voltage to supply to the flush regulating valve.

Preferably, the first preset time is longer than the second preset time.

### ADVANTAGEOUS EFFECTS

As described above, the automatic flushing apparatus of a membrane filter in a water purifier can automatically flush water out of the membrane filter at a preset time period according to purifying time of the membrane filter in order to periodically and automatically remove scales from the inside of the membrane filter under the pressure of the water flushed therefrom.

### BRIEF DESCRIPTION OF THE DRAWINGS

FIG. 1 is a construction view of a purifying apparatus of a conventional water purifier;

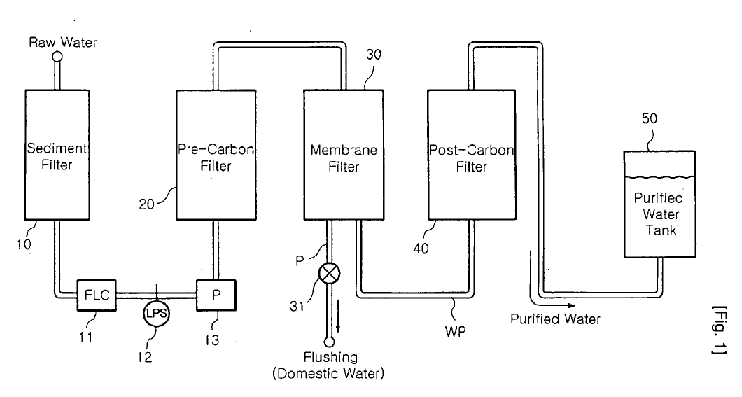

FIG. 2 is a construction view of an automatic flushing apparatus of a membrane filter in a water purifier according to the invention; and

FIG. 3 is a circuit diagram of a controller shown in FIG. 2.

### BEST MODE FOR CARRYING OUT THE INVENTION

The present invention will now be described more fully hereinafter with reference to the accompanying drawings, in which the similar reference signs are used to designate the similar components throughout the accompanying drawings.

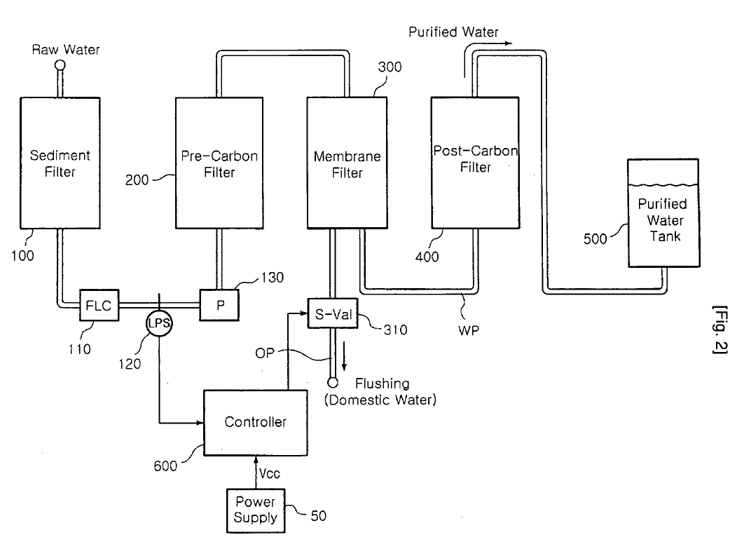

FIG. 2 is a construction view of an automatic flushing apparatus of a membrane filter in a water purifier according to the invention. Referring to FIG. 2, the water purifier includes a sediment filter 100 for removing fine foreign materials from raw water, a pre-carbon filter 200 for removing chemicals harmful to the human body from the water fed from the sediment filter 100, a membrane filter 300 for removing heavy metals from the water fed from the pre-carbon filter 200, a post-carbon filter 400 for removing unpleasant taste or smell and coloring matters from the water fed from the membrane filter 300 and a water tank 500 for containing purified water fed from the post-carbon filter 400.

The water purifier also includes an FLC 110 for closing a raw water pipe between the sediment filter 10 and the pre-carbon filter 20 when the water therein exceeds an adequate level and a power supply 50 for supplying voltages necessary for water-purifying operations.

The automatic flushing apparatus of a membrane filter of the invention applicable to such a water purifier includes an LPS 120 for detecting the water pressure in the water pipe connected between the sediment filter 100 and the pre-carbon filter 200 to supply a pumping voltage if the water pressure is an adequate pressure or higher, a pump 130 for pumping the water fed from the sediment filter 100 to the pre-carbon filter 200 upon receiving the pumping voltage from the LPS 120, a controller 600 for enabling controlled flushing or discharging of the water from the inside of the membrane filter 300 for a period and at an interval of a first preset time from a time point where the pumping voltage is detected, and a flush regulating valve 310 for opening a flush pipe OP of the membrane filter 300 during the controlled flushing by the controller 600.

With such an automatic flushing apparatus of this embodiment, when the water in the membrane filter 300 is flushed or discharged out by the flush regulating valve 310, scales can be removed from the inside of the membrane filter 300 under the pressure of the water flushed therefrom.

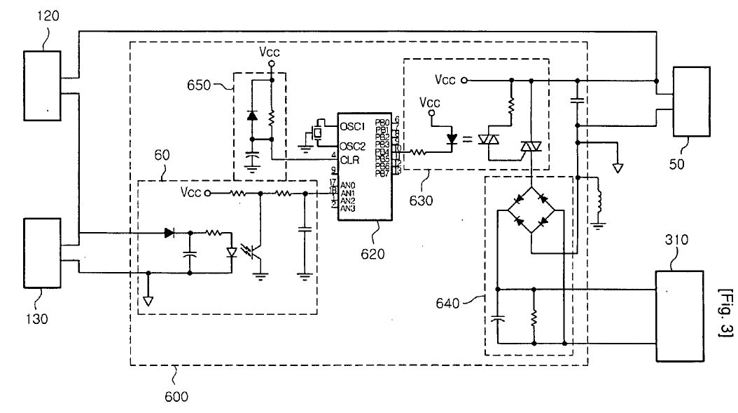

FIG. 3 is a circuit diagram of a controller shown in FIG. 2. Referring to FIG. 3, the controller 600 includes a voltage detector 610 for detecting a pumping voltage applied to the pump 140 via the LPS 120, a microprocessor 620 for supplying a flush signal for a period of a second preset time and at an interval of the first preset time from a time point where a detection voltage is received from the voltage detection, a power switch for supplying an AC flush voltage in response to the flush signal of the microprocessor 620 and a flush power supply 640 for converting the AC flush voltage from the power switch 630 into a DC flush voltage to supply to the flush regulating valve 310.

The microprocessor 620 may be formed of an Integrated Circuit (IC), and include a driving voltage detector circuit 650 for detecting the driving voltage (Vcc) fed from the power supply 50. Here, for reliable operation, the microprocessor 620 can be set or reset according to the magnitude of the voltage through the driving voltage detector circuit 650.

The first preset time is set longer than the second preset time. For example, in application of this embodiment, the first preset time may be set to 45 minutes, and the second preset time may be set to 20 seconds.

In addition, as shown in FIG. 3, the voltage detector 610 may be comprised of a diode, a capacitor, a photo coupler and a resistor, the power switch 630 may be comprised of a photo-coupler and a triac, and the flush power supply 640 may be comprised of a bridge diode.

### MODE FOR THE INVENTION

Hereinafter the operations and effects of the invention will be described in detail with reference to the accompanying drawings.

Describing an operation of the water purifier to which the apparatus of the invention is provided with reference to FIGS. 2 and 3, the raw water such as tap water is purified through the sediment filter 100, the pre-carbon filter 200, the membrane filter 300 and the post-carbon filter 400, and then contained in the water tank 500.

In such a process, the FLC 110 closes the water pipe between the sediment filter 10 and the pre-carbon filter 20 when the water therein exceeds an adequate level. The LPS 120 detects the water pressure in the water pipe connected between the sediment filter 100 and the pre-carbon filter 200, and supplies a pumping voltage to the pump 130 if the detected water pressure is an adequate pressure or higher. Here, the pump 130 acts to pump the water from the sediment filter 100 to the pre-carbon filter 200 when supplied with the pumping voltage from the LPS 120.

Accordingly, at a water level that is the adequate water level or lower and at a water pressure that is the adequate water pressure or higher, the water purifier normally performs a water purification process by the pump 130.

Now a process of removing the scales from the inside of the membrane filter will be described.

In the automatic flushing apparatus of a membrane filter of the invention, the controller 600 controls the flushing or discharging of the water from the inside of the membrane filter 300 for a period at an interval of a first preset time from a time point where a pumping voltage is detected. Here, the controller 600 detects the pumping voltage of the LPS 120 to determine whether or not the pump 130 is operating.

Under the flush control by the controller 600, the flush regulating valve 310 opens the flush pipe OP of the membrane filter 300, such that the water is flushed or discharged from the inside of the membrane filter 300 through the flush pipe OP. While the water is flushed out from the inside of the membrane filter 300 through the flush regulating valve 310, scales are also discharged and removed from the inside of the membrane filter 300 under the pressure or force of water flushed therefrom.

Referring to FIG. 3, the voltage detector 610 of the controller 600 detects a pumping voltage supplied to the pump 140 via the LPS 120, and outputs a detection voltage to the microprocessor 620. The microprocessor 620 outputs a flush signal to the power switch 630 for a period of a second preset time and at an interval of the first preset time from the time point where the detection voltage is received from the voltage detector 610. The power switch 630 supplies an AC flush voltage to the flush power supply 640 in response to the flush signal of the microprocessor 620. The flush power supply 640 converts the AC flush voltage from the power switch into a DC flush voltage to supply to the flush regulating valve 310.

Although the first and second preset times may be varied according to various conditions such as water and installation environment, if the first preset time is set to 45 minutes and the second preset time is set to 20 seconds as an instance, a water purifying process is performed for 45 minutes from the time point where the pump starts its operation but the water is flushed out from the inside of the membrane filter 300 for 20 seconds with an interval of 45 minutes. Then, the water removes the scales from the inside of the membrane filter 300 while being flushed out.

As described hereinbefore, this embodiment of the invention can repeatedly perform the process of purifying water for a preset time period (e.g., 45 minutes) and flushing the water from the inside of the membrane filter for a relatively short time period (e.g., 20 seconds) in order to periodically remove scales built up inside the membrane filter. This as a result can maintain the inside of the membrane filter clean and thus prolong the lifetime of the membrane filter.

While the present invention has been described with reference to the particular illustrative embodiments and the accompanying drawings, it is not to be limited thereto but will be defined by the appended claims. Rather, it is to be appreciated that those skilled in the art can make various substitutions, changes and modifications to the apparatus of the embodiments of the present invention without departing from the scope and spirit of the present invention.

### INDUSTRIAL APPLICABILITY

According to the illustrative embodiment of the invention as described hereinbefore, the automatic flushing apparatus of a membrane filter in a water purifier can automatically flush water out of the membrane filter at a preset time period according to purifying time of the membrane filter in order to periodically and automatically remove scales from the inside of the membrane filter under the pressure of the water flushed therefrom.

1. An automatic flushing apparatus of a membrane filter in a water purifier, which includes a sediment filter, a pre-carbon filter and the membrane filter to sequentially filter raw water, the apparatus comprising:
an LPS for detecting water pressure in a water pipe connected between the sediment filter and the pre-carbon filter to supply a pumping voltage if the water pressure is an adequate pressure or higher;
a pump for pumping water fed from the sediment filter to the pre-carbon filter upon receiving the pumping voltage from the LPS;
a controller for enabling controlled flushing of the water from the inside of the membrane filter for a period and at an interval of a first preset time from a time point where the pumping voltage is detected; and
a flush regulating valve for opening a flush pipe of the membrane filter during the controlled flushing by the controller,
whereby the water is flushed out from the inside of the membrane filter through the flush regulating valve while removing scales from the inside of the membrane filter under flushing pressure thereof.

2. The automatic flushing apparatus according to claim 1, wherein the controller includes:
a voltage detector for detecting a pumping voltage applied to the pump via the LPS;
a microprocessor for supplying a flush signal at an interval of the first preset time and for a period of a second preset time from a time point where a detection voltage is received from the voltage detection;
a power switch for supplying an AC flush voltage in response to the flush signal of the microprocessor; and
a flush power supply for converting the AC flush voltage from the power switch into a DC flush voltage to supply to the flush regulating valve.

3. The automatic flushing apparatus according to claim 1, wherein the first preset time is longer than the second preset time.
